(19) United States
(12) Patent Application Publication
(10) Pub. No.: US 2006/0249984 A1
(43) Pub. Date: Nov. 9, 2006

(54) Mounting of a topper on a pickup truck

(76) Inventor: Charles Richard Hale, Wichita, KS (US)

Correspondence Address: Charles Hale, 4480 S. Meridian # 242, Wichita, KS, 67217, US

(21) Appl. No.: 11/124,970

(22) Filed: May 9, 2005

(51) Int. Cl. B60P 3/325

(52) U.S. Cl. 296/167

(57) ABSTRACT

A topper provided with four mounting brackets that are sealingly secured to the lower coplanar edges of its side walls, with the brackets having a plurality of depending legs supporting the strap and latch system included in the construction. The depending legs serve as supports for the topper while it is dismounted and not in use thus protecting the sealing means. The mounting system is provided with a lower surface seal for contact with the side wall flanges of the pickup truck while straps and latches secure the topper in mounted and immobile condition.

### CROSS-REFERENCE TO RELATED APPLICATIONS

This application claims the benefit of provisional patent application No. 60/569,521, filed 2004 May 10 by the present inventor.

### FEDERALLY SPONSORED RESEARCH

None.

### SEQUENCE LISTING OR PROGRAM

None.

### BACKGROUND OF THE INVENTION

1. Field of Invention

The present invention relates to new and useful improvements in apparatus for detachably mounting toppers on pickup trucks, and more particularly relates to such apparatus that can be expeditiously and precisely oriented with respect to a topper and thereupon be sealingly fixed thereto. When so assembled the assembly can thereafter be sealingly and detachably secured to the upper edges of the side walls of the pickup truck.

2. Prior Art

Structures for at least partially covering and enclosing the space overlying the beds of pickup trucks have been employed for years.

Usually such structures have been mounted in a detachable fashion so they could be set aside, as their continued presence obstructed or precluded the use of the truck for many other purposes or was incompatible with accommodating some kinds of loads or cargo.

A great number of different proposals have heretofore been made for detachably mounting such structures. An appreciation of the general nature of such prior art proposals may be gleaned on considering the disclosures of some prior U.S. patents.

U.S. Pat. No. 4,531,774 issued on Jul. 10, 1985 to Whatley, discloses an anchor structure that can be forcibly wedged in a stake pocket or socket of a truck wall for securing a tool box or the like thereon.

U.S. Pat. No. 1,425,596 issued on Aug. 15, 1922 to Kramer, disclose depending posts fixed to the side walls of a truck for reception in sockets along edges of a truck flat bed.

U.S. Pat. No. 4,079,989 issued on Mar. 21, 1978 to Robertson, discloses a U-shaped frame mounted to the upper edges of the front and side walls of a pickup truck by means that utilize the customary socket holes. A cover is pivoted to the front part of the U-shaped frame.

U.S. Pat. No. 3,069,199 issued on Dec. 18, 1962 to Reardon et al, discloses the side walls of a pickup truck covering having ports that are projected into the socket holes.

U.S. Pat. No. 3,765,713 issued on Oct. 16, 1973 to Suitt, discloses a carrier rack mounted on a pickup truck by structure that includes depending posts that can be inserted in socket holes.

U.S. Pat. No. 4,423,899 issued on Jan. 3, 1984 to Langmead, discloses mounting structure utilizing depending posts for insertion in socket holes.

U.S. Pat. No. 4,269,443 issued on May 26, 1981, to Farmer, discloses a van body secured by bolts to a sill about the periphery of a flat truck bed.

U.S. Pat. No. 3,741,605 issued on Jun. 26, 1973 to Lee, discloses the use of stake sockets at lateral edges of low slung truck beds.

U.S. Pat. No. 4,444,427 issued Apr. 24, 1984 to Martin, discloses frame members having depending posts or stakes received in the stake socket of a pickup truck. Such frame members are secured to overlying pocket or socket defining structures by threaded means.

U.S. Pat. No. 4,123,099 issued on Oct. 31, 1978 to Mashigan, discloses a topper-like structure mounted on a pickup truck with padding interposed at the juncture of such structure and the side walls of the truck.

U.S. Pat. No. 4,815,787 issued on Mar. 28, 1989 to Hale, discloses a U-shaped frame having depending posts that mate with sockets along the flanged upper edges of the pickup truck side walls. The posts serve as supports when the topper is dismounted. The entire structure is designed for use in conjunction with self-adhesive sealing means.

The aforementioned devices and structures are primarily concerned with the utilization of depending posts that correspond to socket holes in pickup side walls. The current trend in pickup truck design omits the socket holes relying instead on tie down hooks thus making the previous inventions obsolete for newer models.

### OBJECTS AND ADVANTAGES

My invention involves the provision of four angled brackets specially adapted to be sealingly secured to the lower periphery of a toppers side walls. The brackets are secured to the toppers by bolts extending through slotted openings, two in each bracket, that also serve as guides for drilling fastening holes in the lower lip of the topper.

Sealing means are adhesively secured to the underside of the brackets as well as the underside of the topper.

Bracket construction includes parallel leg posts whereby sealing means and topper edges are sheltered when not in operation as well as tie down straps that work in conjunction with hooks that are bolted on the pickup bed to secure the entire composition to the pickup body.

### SUMMARY

The purpose of the invention is to provide a topper mounting assembly that can be accurately and permanently secured to a topper with a weatherproof connection, with such mounting assembly enabling the topper to be selectively stored in and off the ground position of releasably secured to a pickup truck with a weatherproof connection therebetween.

A closely related object is to afford shelter or secure location for the seal when the latter is not applied to bear against the pickup walls.

A broad aspect of the invention involves, for use in the detachable mounting of a topper on a pickup truck, mounting structures comprising four identical brackets adapted to conform to the side walls of any make or model of pickup truck said frame including parallel leg posts extending from and joined to L-shaped base plates with depending flanged edges.

### DRAWINGS

FIG. 1 is an exploded and fragmentary assembly view of the mounting means and it's operative association with the side walls of a pickup truck and the flanged lower edges of the walls of a topper.

FIG. 2 is an enlarged view of the mounting bracket in perspective detail.

FIG. 3 is an elevational view of the mounting bracket in actual size.

FIG. 4 is a side view of the mounting bracket in actual size.

FIG. 5 is an enlarged and exploded view of the installational method employed in the utilization of the mounting bracket.

FIG. 6 is a cross-section of a topper, a pickup truck side wall, and the mounting bracket, showing proper installation and function.

FIG. 7 shows location of all four mounting brackets on the actual pickup side walls. These specific locations ensure exact positioning of the topper each and every time it is mounted.

### REFERENCE NUMERALS

10 topper
11 aluminum bracket
13 rubber seal
14 latch hook
15 top edge of pickup truck
16 tie-down brackets
17 pickup sidewall
18 pickup inside edge
19 1×1 aluminum tube
20 fastening strap—from latch to hook
21 strap bracket
22 fastening strap—from #21 to latch
23 latch
24 slot
25 carriage bolt
26 washer
27 nut
28 bolt hole

### DETAILED DESCRIPTION OF THE PREFERED EMBODIMENT AS WELL AS PRACTICAL CONSTRUCTION

Refering now to the drawings wherein like numerals designate like parts throughout the various views, the numeral 10 designates a conventional topper, while numbers 15, 17, and 18 show the involved surfaces of a conventional pickup truck. The instant invention 11 is concerned with the means for mounting the topper 10 on the pickup bed 15, 17, and 18 and the same will now be described.

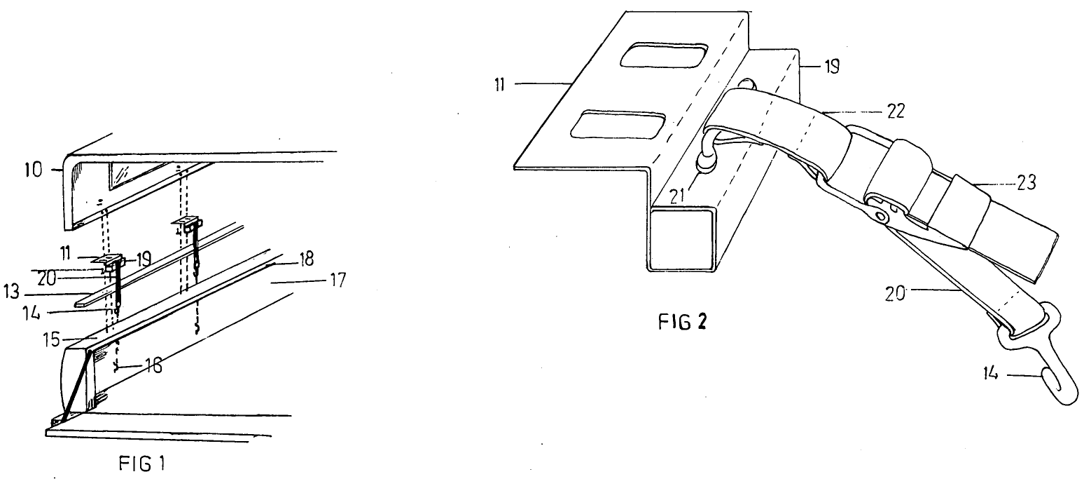

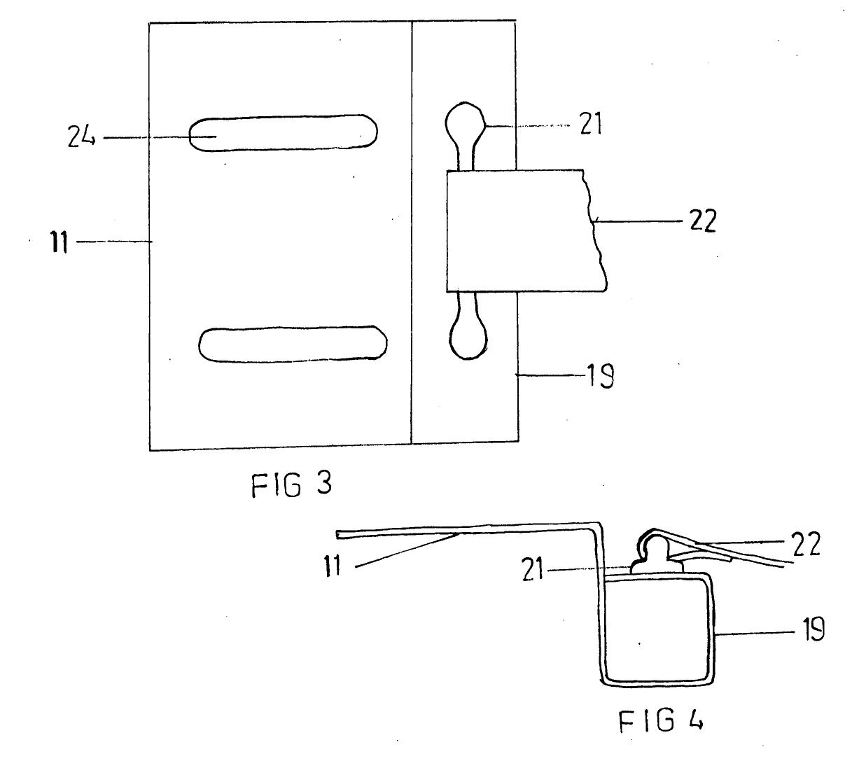

The mounting means include an L-shaped bracket 11 with a section of square tubing 19 attached at the depending flanged edge. hereto in this inception constructed of aluminum sheet and tubing with the eventuallity of being constructed of extruded or cast plastic. The fastening strap section 22 is attached to square tubing 19 by means of a U-shaped fitting 21 either pop riveted to tube 19 or in the plastic inception by means of self-tapping screws. Latch 23 is sewn onto nylon strap 22 while connecting hook 14 is sewn to fastening strap 20 joining latch 23 to fastening strap 22. All of which are clearly shown in FIG. 2.

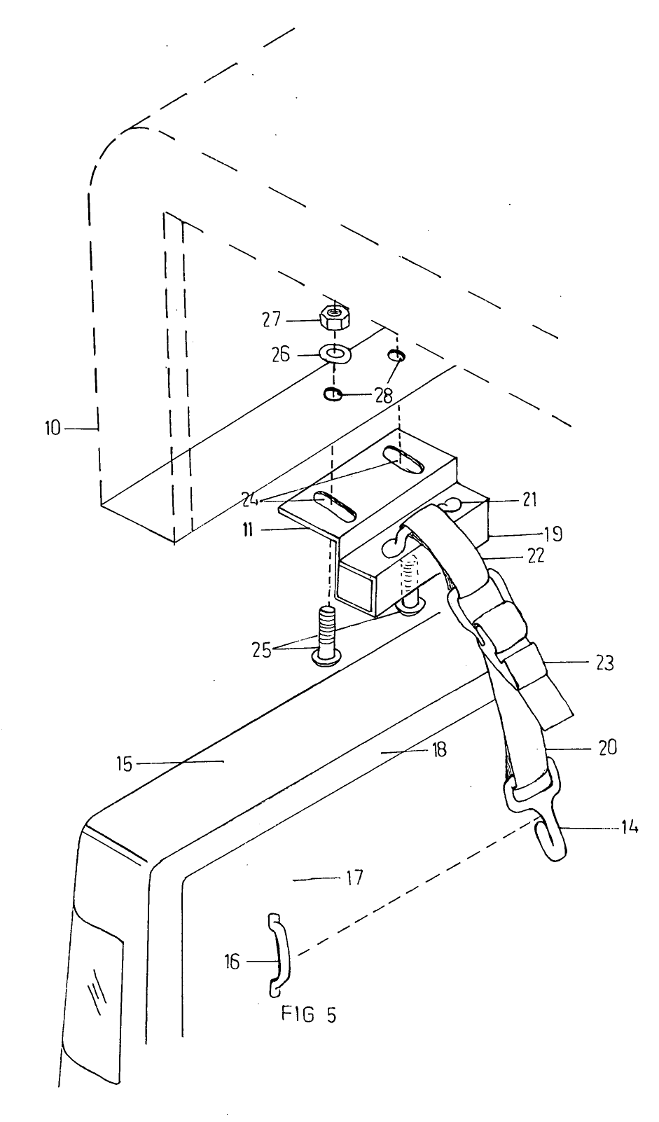

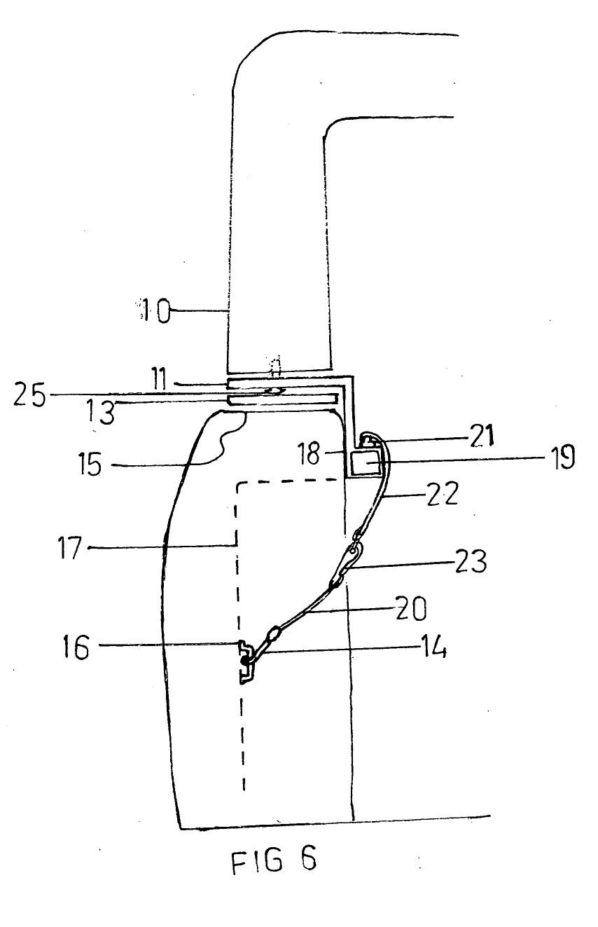

Mounting means 11 are attached to topper 10 by carriage bolts 25 inserted through slots 24 and into pre-drilled holes 28. These are secured with washers 26 and nuts 27 as clearly shown in FIG. 5. A premanufactured self-adhesive seal 13 is then applied all along the lower periphery of topper 10 covering all four mounting devices as shown in FIG. 1.

Once the mounting devices 11 and premanufactured seal 13 are attached to topper 10 the entire is then lowered onto the edge of pickup bed 15. Latch hooks 14 are secured to tie down brackets 16 which are factory standard equiptment on pickup trucks and are located on inner bed wall 17. Fastening strap 20 is pulled tight and firmly secured by latch 23 preventing any movement of topper 10 against pickup edge 15.

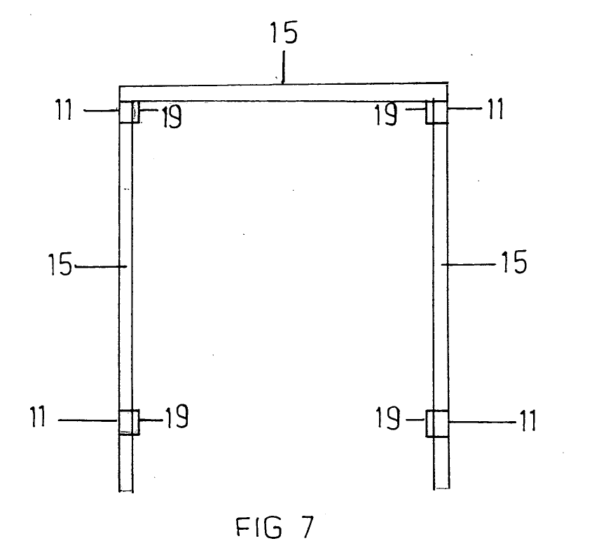

Mounting brackets 11 are positioned as shown in FIG. 7 along the top edge 15 of the pickup truck bed. This positioning ensures that each and every time the topper 10 is mounted to the pickup bed 15 the brackets 11 are situated in exactly the same location and in perfect proximity to pickup tie down brackets 16.

Mounting bracket 11 is designed with tubing feature 198 to provide means for storing topper 10 when not mounted on the pickup truck 15 eliminating the need for blocks or scaffolding thus protecting seal 13 from damaging contact with external surfaces.

Having now fully described the invention as to its structure, function, and use, attention is now directed to the appended claims for an appreciation of the actual scope of the invention:

1. For use in the detachable mounting of a topper on a pickup truck, four identical mounting brackets conforming to the side walls of a pickup truck, said brackets including parallel legs comprised of tubing and joined at the depending edge of the mounting bracket as well as a strapping system, all functioning as means for securely joining a topper to a pickup truck in an accurate and timely fashion.

2. A mounting bracket which when combined with premanufactured sealing means, will combine not only the means for securing a topper to a pickup truck, but also provide a safe and secure means for storing a topper while not applied to bear against the pickup walls, thus preserving the integrity and functionability of the sealing means.

3. When correctly utilized, the mounting brackets in conjunction with the sealing means and strapping system, provide accurate positioning each and every time the topper is mounted on the pickup truck, eliminating the need for measuring as well as the need for clamps.

4. The mounting means in conjunction with tie-down brackets, which are standard equiptment on pickup trucks, anchor the topper firmly and securely against the pickup bed utilizing adjustable straps and a latching system making the mounting brackets universally functional as to all makes and models of pickup trucks.
